(19) United States
(12) Patent Application Publication
(10) Pub. No.: US 2013/0008551 A1
(43) Pub. Date: Jan. 10, 2013

(54) LATERAL PIPE LINING MATERIAL, METHOD FOR PRODUCTION OF SAME, AND LATERAL PIPE LINING PROCESS

(76) Inventors: Koji KANETA, Hiratsuka-shi (JP); Kenji Fujii, Hiratsuka-shi (JP); Hiroyoshi Kaneta, Hiratsuka-shi (JP)

(21) Appl. No.: 13/535,906

(22) Filed: Jun. 28, 2012

(30) Foreign Application Priority Data
Jul. 8, 2011 (JP) 2011-151756

(51) Int. Cl. F16L 9/14; B32B 37/14

(52) U.S. Cl. 138/141; 156/293

(57) ABSTRACT

A resin sheet that is comprised of a thermoplastic resin capable of being thermally welded to a lining material of a main pipe is attached to a flange of a lateral pipe liming material via a resin-absorbing material. The resin sheet and the resin-absorbing material are thermally welded. The flange and the resin-absorbing material are respectively impregnated with a thermoplastic resin, which is cured to bond the flange and the resin-absorbing material. A similar configuration is provided to the bottom side of the flange as well. The resin sheet of the thermoplastic resin is integrally bonded to the flange, so that the flange of the lateral pipe lining material and the main pipe lining material can be reliably bonded by a simple method through thermally welding of the lining material of the main pipe and the resin sheet, even in a case in which the flange is hard.

### BACKGROUND OF THE INVENTION

1. Field of the Invention

The present invention relates to a lateral pipe lining material comprising a tubular resin-absorbing material with a flange formed at one end thereof, a method for production thereof, and a lateral pipe lining process for inserting the lateral pipe lining material into a lateral pipe from a lateral pipe opening of a main pipe to line the lateral pipe.

2. Description of the Related Art

In cases where sewer pipes or other pipelines buried underground are aged, a pipe lining process is employed in which the inside peripheral surface is lined to repair the pipeline without having to excavate the pipeline from the ground.

For example, Japanese Patent Laid-open Publication No. 2008-25761 discloses a process for lining a main pipe using a main pipe lining material comprising a resin pipe made of a thermoplastic resin with a protruding rib being wound in a spiral pattern about the outer circumference thereof for the purposes of reinforcement. The main pipe lining material is folded up and drawn into the main pipe, then restored to a circular cross section. A grout material is injected between the inside peripheral surface of the main pipe and the outside peripheral surface of the resin pipe.

A process disclosed in Japanese Patent Laid-open Publication No. 2006-130899 employs a main pipe lining material comprised of a flexible tubular resin-absorbing material that is impregnated with a curing resin and covered on the outside peripheral surface with a highly airtight film. The main pipe lining material is inserted into a pipeline while being everted by fluid pressure and is maintained in a state of being pressed against the inside peripheral surface thereof by fluid pressure. The main pipe lining material is then warmed to cure the curing resin impregnated therein and line the inside peripheral surface of the pipeline.

Such a process can also be applied to a lateral pipe that branches from a main pipe. In the case of lining a lateral pipe, a tubular lateral pipe lining material is packaged in a pressure bag, and a flange that is formed at one end thereof is seated in the head collar of a work robot, which is guided into the main pipe and driven so as to bring the flange of the lateral pipe lining material into close contact with the periphery of the lateral pipe opening of the main pipe. Once compressed air is supplied into the pressure bag, the lateral pipe lining material is inserted into the lateral pipe while being everted by the pressure of the compressed air. After eversion and insertion has been completed along the entire length of the lateral pipe, the lateral pipe lining material is pressed against the inside peripheral surface of the lateral pipe, and is warmed to cure the thermosetting resin impregnated therein, thereby lining the inside peripheral surface of the lateral pipe.

Lateral pipe lining of this sort is typically carried out prior to main pipe lining, but is sometimes carried out after main pipe lining has been done (also called after-lining).

In the case of after-lining, a packing is attached onto the flange of the lateral pipe lining material, or an adhesive is applied thereto, in order to enhance close contact of the flange of the lateral pipe lining material with the periphery of the lateral pipe opening of the main pipe for improvement of joining of the main pipe lining material and the lateral pipe lining material to prevent inflow of underground water together with sediment into the main pipe from the portion where the lateral pipe and the main pipe intersect (see, Japanese Patent Laid-open Publication No. 2008-38393).

However, the process according to Japanese Patent Laid-open Publication No. 2008-38393 involves attaching a packing or applying an adhesive to the flange of the lateral pipe lining material, and bringing it into close contact with the main pipe lining material for joining with the main pipe lining material. Therefore, drawbacks include high manufacturing costs, and, particularly in cases where the flange of the lateral pipe lining material is hard, insufficient contact therewith, so that joining of the lateral pipe lining material and the main pipe lining material is insufficient.

### SUMMARY OF THE INVENTION

It is an object of the present invention to provide a lateral pipe lining material which improves joining of the lateral pipe lining material and the main pipe lining material when a lateral pipe is lined; a method for production thereof; and a lateral pipe lining process.

According to the present invention, a lateral pipe lining material is provided that comprises a flexible tubular resin-absorbing material that is folded back at one end to form a flange and is inserted into a lateral pipe that intersects with a main pipe lined with a lining material of a thermoplastic resin. The lateral pipe lining material comprises:

an annular resin sheet disposed at a side of the flange facing towards the lateral pipe and comprised of a thermoplastic resin capable of being thermally welded to the lining material of the main pipe; and

an annular resin-absorbing material disposed between the resin sheet and the flange;

wherein the resin sheet and the annular resin-absorbing material are thermally welded, and each of the flange and the annular resin-absorbing material is impregnated with a thermosetting resin, which is cured to join the flange and the annular resin-absorbing material.

The present invention also provides a method for producing a lateral pipe lining material comprising a flexible tubular resin-absorbing material that is folded back at one end to form a flange and is inserted into a lateral pipe that intersects with a main pipe lined with a lining material of a thermoplastic resin. The method comprises:

disposing at a side of the flange facing towards the lateral pipe an annular resin sheet comprising a thermoplastic resin capable of being thermally welded to the lining material of the main pipe;

disposing an annular resin-absorbing material between the resin sheet and the flange;

impregnating each of the flange and the annular resin-absorbing material with a thermosetting resin; and

heating the flange, the annular resin-absorbing material and the resin sheet to weld the resin sheet and the annular resin-absorbing material and to cure the thermosetting resin in the flange and the annular resin-absorbing material, thereby joining the flange and the annular resin-absorbing material.

The present invention also provides a lateral pipe lining process for lining a lateral pipe, employing the lateral pipe lining material according to claim 1. The process comprises:

impregnating the tubular resin-absorbing material of the lateral pipe lining material with a curing resin;

disposing the lateral pipe lining material impregnated with the curing resin such that a flange thereof is pressed against the main pipe in the vicinity of an opening of the lateral pipe;

applying pressure to the lateral pipe lining material for eversion and insertion into the lateral pipe;

curing, after eversion and insertion, the resin impregnated into the lateral pipe lining material in a state in which the lateral pipe lining material is pressed against the lateral pipe inside peripheral wall, thereby lining the lateral pipe; and

heating the resin sheet on the lateral pipe side while being pressed against the lining material of the main pipe at the beginning of insertion of the lateral pipe lining material, or during insertion, or after insertion thereof for welding to the lining material of the main pipe.

According to the present invention, a resin sheet comprised of a thermoplastic resin capable of being thermally welded to the lining material of a main pipe is integrally joined to the flange of the lateral pipe lining material. Therefore, by thermally welding the lining material of the main pipe and the resin sheet, the flange of the lateral pipe lining material and the main pipe lining can be joined reliably by a simple method, even in a case in which the flange is hard. This makes it possible to prevent inflow of underground water together with sediment from the portion where the lateral pipe and the main pipe intersect.

### BRIEF DESCRIPTION OF THE DRAWINGS

FIG. 1 is side view showing in partial cross section the exterior of a main pipe lining material for lining a main pipe;

FIG. 2 is an illustrative view showing the interior of the main pipe lined using the main pipe lining material of FIG. 1;

FIG. 3 is an illustrative view showing a lined main pipe when the lateral pipe opening of the main pipe has been opened;

FIG. 4 is a perspective view of a lateral pipe lining material for lining a lateral pipe that intersects with a main pipe;

FIG. 5 is a perspective view showing a tubular resin-absorbing material of a lateral pipe lining material;

FIG. 6a is a perspective view showing a production step of a lateral pipe lining material;

FIG. 6b is a sectional view thereof;

FIG. 7a is a perspective view continuing on from that of FIG. 6a, and describing a production step;

FIG. 7b is a sectional view thereof;

FIG. 8a is a perspective view continuing on from that of FIG. 7a, and describing a production step;

FIG. 8b is a sectional view thereof;

FIGS. 9a and 9b are sectional views continuing on from that of FIG. 8a, and describing a production step;

FIGS. 10a and 10b are sectional views continuing on from that of FIG. 9a, and describing a production step;

FIG. 11a is a perspective view showing a state in which a heater is seated in a head collar attached to a work robot;

FIG. 11b is a perspective view when a lateral pipe lining material is seated on the heater;

FIG. 12 is an illustrative view showing a step of lining a lateral pipe with a lateral pipe lining material;

FIG. 13 is an illustrative view continuing on from FIG. 12, showing a lateral pipe lining step;

FIG. 14 is an illustrative view continuing on from FIG. 13, showing a lateral pipe lining step;

FIG. 15 is a sectional view showing in detail lining of the periphery of a lateral pipe opening of a main pipe;

FIG. 16 is a sectional view showing another embodiment of a lateral pipe lining material;

FIG. 17 is a sectional view showing another embodiment of a lateral pipe lining material; and

FIG. 18 is a sectional view showing another embodiment of a lateral pipe lining material.

Further features of the invention, its nature and various advantages will be more apparent from the accompanying drawings and following detailed description of the invention.

### DESCRIPTION OF THE PREFERRED EMBODIMENTS

In the following description, a lateral pipe lining material for lining a lateral pipe that branches from a main pipe, a method for production thereof, and a lateral pipe lining process are described via embodiments with reference to the drawings. The main pipe is an existing pipe in a sewer line, water supply line, agricultural water channel, or the like; and the lateral pipe is a pipe that is attached to the main pipe, branching from the main pipe to extend aboveground.

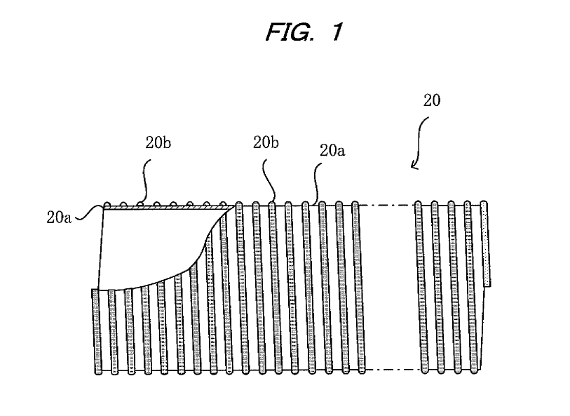

FIG. 1 shows in partial cross section a main pipe lining material 20 for lining a main pipe. The main pipe lining material 20 is constituted by a tubular resin pipe 20a having an outside diameter smaller than the inside diameter of the main pipe. The main pipe lining material 20 has a protruding rib 20b wound in a spiral pattern about the outside wall thereof for reinforcing purposes. The resin pipe 20a is formed, for example, of a soft thermoplastic resin such as polyethylene, polypropylene, or the like, and is optionally compounded with a predetermined proportion of an elastomer in order to raise the elasticity of the resin pipe 20a. The resin pipe 20a can also have a two-layer structure, rather than a single layer as illustrated. The protruding rib 20b is made of the same resin as the resin pipe 20a, but is harder than the resin pipe 20a due to a change in the compounding ratio of the elastomer. Such a main pipe lining material 20 is disclosed in Japanese Patent Laid-open Publication No. 2008-25761, for example.

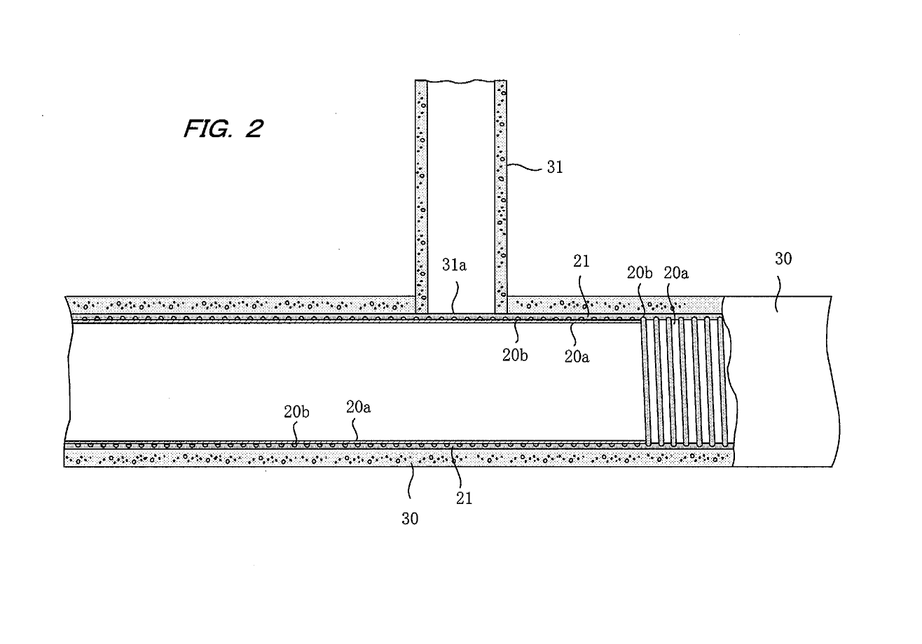

The resin pipe 20a and the protruding rib 20b are elastically deformable, so that the main pipe lining material 20 may be folded, for example, into a heart shape, and then as shown in FIG. 2, drawn inside the main pipe 30 from a manhole (not illustrated) at one end. The main pipe lining material is then restored to a circular cross section by self-repelling force, or by supplying compressed air into the resin pipe 20a. A gap is formed between the outside peripheral surface of the resin pipe 20a and the inside peripheral surface of the main pipe 30. A grout material 21 is injected into the gap and hardened to unify the main pipe 30 and the main pipe lining material 20 and construct a composite pipe.

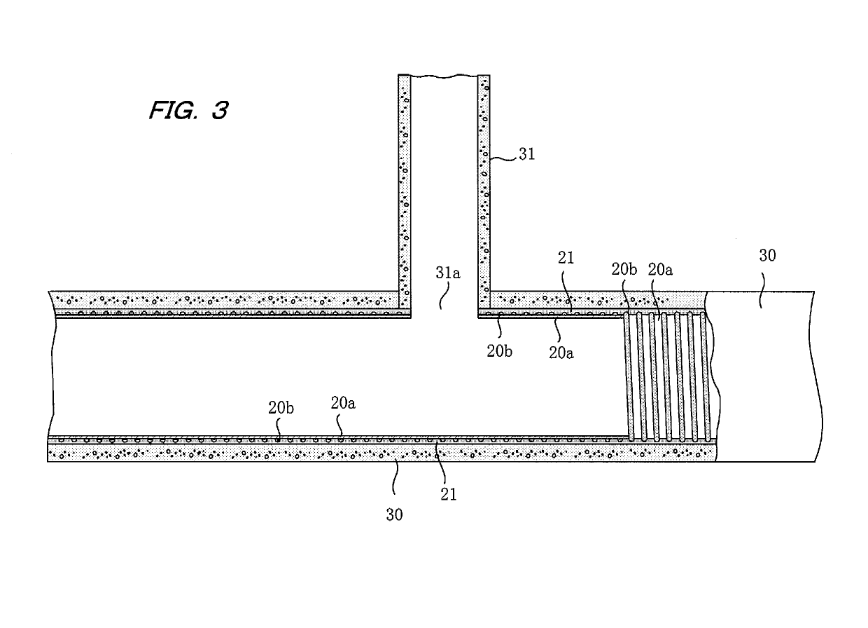

When the main pipe 30 is lined with the main pipe lining material 20, a main pipe-side opening 31a of a lateral pipe 31 that branches from the main pipe 30 becomes closed off. The lateral pipe opening 31a closed off by the main pipe lining material 20 is then cut open from the main pipe side or from the lateral pipe side by a known method in order to restore the original communication between the main pipe 30 and the lateral pipe 31, as shown in FIG. 3.

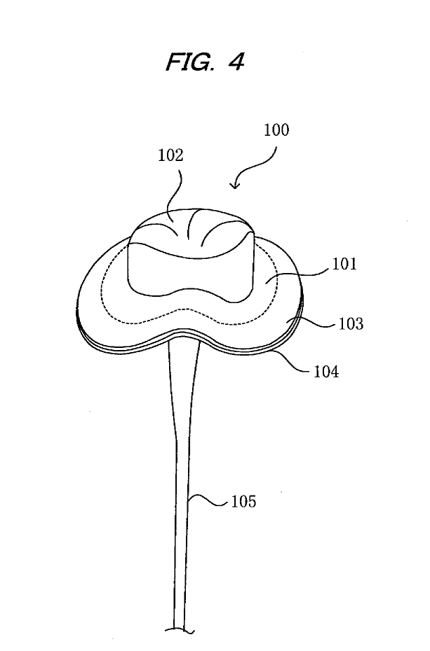

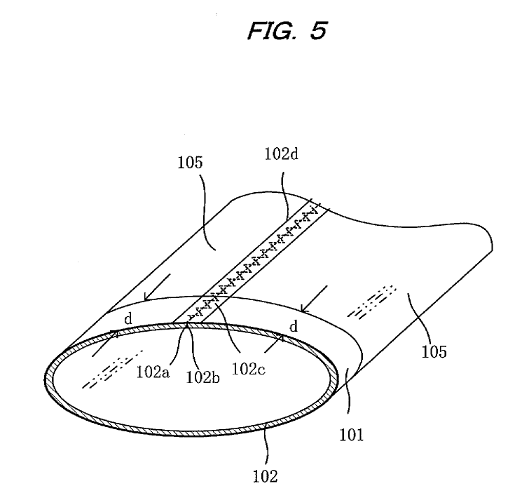

FIG. 4 is a perspective view of a lateral pipe lining material for lining the lateral pipe 31, and FIGS. 5 to 10 are illustrative views used for describing a method for producing same.

A lateral pipe lining material 100 has a flexible, tubular resin-absorbing material 102 coated on the outside peripheral surface (which becomes the inside peripheral surface when everted) by an airtight plastic film 105, and one end thereof is everted and folded outward to form a flange 101. An upper resin sheet 103 of annular shape comprising a soft thermoplastic resin, for example, polyethylene, polypropylene, or the like, is attached to the flange 101 on the surface thereof facing towards the lateral pipe (the surface on the upper side in FIG. 4), and a lower resin sheet 104 of the same shape and same material is attached to the flange 101 on the surface thereof on the side opposite the lateral pipe (the surface on the lower side in FIG. 4). The tubular resin-absorbing material 102 comprises a nonwoven or woven fabric, or a mat employing plastic fibers of polyamide, polyester, polypropylene, or the like; a woven fabric or a mat employing glass fibers; or a nonwoven or woven fabric, or a mat in which the aforementioned plastic fibers and glass fibers are combined. The tubular resin-absorbing material 102 is impregnated with a thermosetting resin, a photocuring resin, or other such liquid curing resin, in uncured form, as will be described later. Polyethylene, polypropylene, or the like is employed in fabricating the plastic film 105.

This lateral pipe lining material 100 is manufactured as follows.

As shown in FIG. 5, a strip of the resin-absorbing material 102 of predetermined width and predetermined length having the highly airtight plastic film 105 thermally welded to one surface thereof is rolled up so that the plastic film 105 constitutes the outside peripheral surface, and both edges 102a, 102b thereof are seamed. The seamed section 102c is stitched together, and joined airtightly by plastic welding with tape 102d of polyethylene, polypropylene, or the like. A portion of width d at an end of the tubular resin-absorbing material 102 is everted and folded outward as discussed below, forming a flange 101, and the upper and lower resin sheets 103, 104 are then attached to this portion. The folded portion of width d of the tubular resin-absorbing material 102 is not covered by the plastic film 105, and the tubular resin-absorbing material 102 remains exposed.

Rather than coating the strip of resin-absorbing material with the plastic film 105 before forming the pipe shape, the uncoated strip of resin-absorbing material may be formed into a pipe shape, and the outside peripheral surface thereof then coated with the plastic film 105, except for the portion of width d on the outside peripheral surface.

As will be discussed later, the tubular resin-absorbing material 102 is everted and inserted into the lateral pipe 31, and expanded to a circular shape. The width of the strip of resin-absorbing material is determined such that the outside diameter of the tubular resin-absorbing material 102 when expanded to circular shape is substantially equal to the inside diameter of the lateral pipe 31, and the length thereof is a length commensurate with the length of the lateral pipe 31 to be lined.

The upper resin sheet 103 and the lower resin sheet 104, which are attached to the portion of width d formed by outward folding of the tubular resin-absorbing material 102, are fabricated by a soft thermoplastic resin that can be thermally welded to the resin employed for the resin pipe 20a of the main pipe lining material 20. For example, in a case in which polyethylene (PE) is employed for the resin pipe 20a, polyethylene is likewise employed in respectively fabricating the upper resin sheet 103 and the lower resin sheet 104. Alternatively, in a case in which polypropylene (PP) is employed in fabricating the resin pipe 20a, polypropylene is likewise employed in respectively fabricating the upper resin sheet 103 and the lower resin sheet 104.

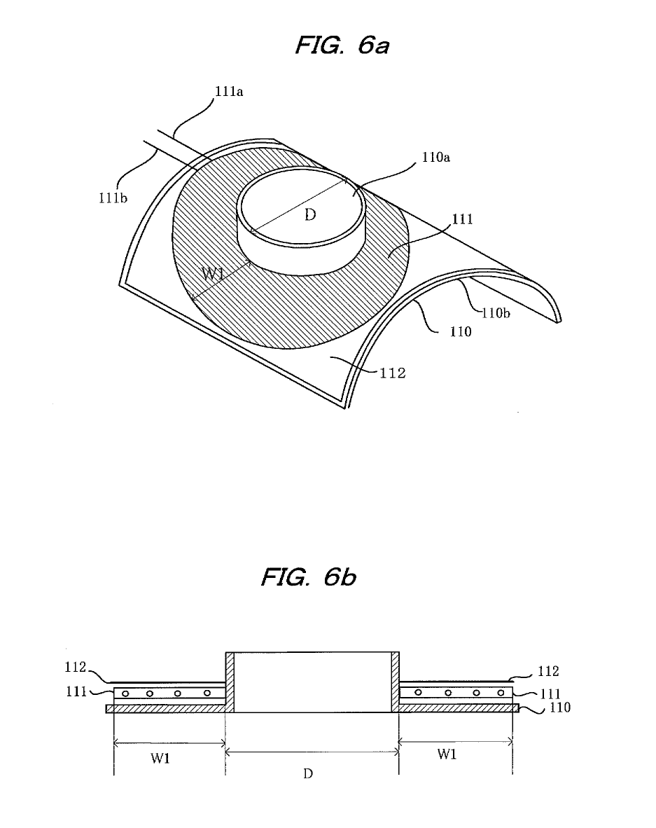

The way in which the upper resin sheet 103 and the lower resin sheet 104 are attached to the lateral pipe lining material 100 is illustrated in FIGS. 6 to 9. In the drawings with cross sections in FIGS. 6 to 9, the thickness, length, width, and other dimensions of the components do not necessary correspond to the actual dimensions, and are partially shown in exaggerated form, in order to facilitate description. The components are actually placed in close contact with each other in a lamellar arrangement in the vertical direction. However, in order to avoid a complicated drawing, the components are shown in appropriately separated form.

As shown in FIGS. 6a and 6b, a jig 110 is prepared that comprises a round tubular section 110a of outside diameter D (in cross section, shown with exaggerated height) and a curved section 110b. Rested on the jig 110 is a ring-shaped heater 111 of an inside diameter equal to D and a ring width of W1 corresponding to the difference between the outside diameter and the inside diameter thereof. The outside diameter D of the round tubular section 110a corresponds to the inside diameter of the tubular resin-absorbing material 102 when expanded to a circular shape, and the curvature of the curved section 110b substantially corresponds to the curvature of the inside peripheral surface of the main pipe 30. The heater 111 is covered with a heat-resistant elastic material such as silicone rubber or the like and is provided therein with a ring-shaped heat-emitting element (nichrome wire) having leads 111a, 111b. The entirety of the heater 111 is covered with a weld-preventing sheet 112 that prevents components disposed above the heater 111 from being melted by the heater 111 and deposited thereon.

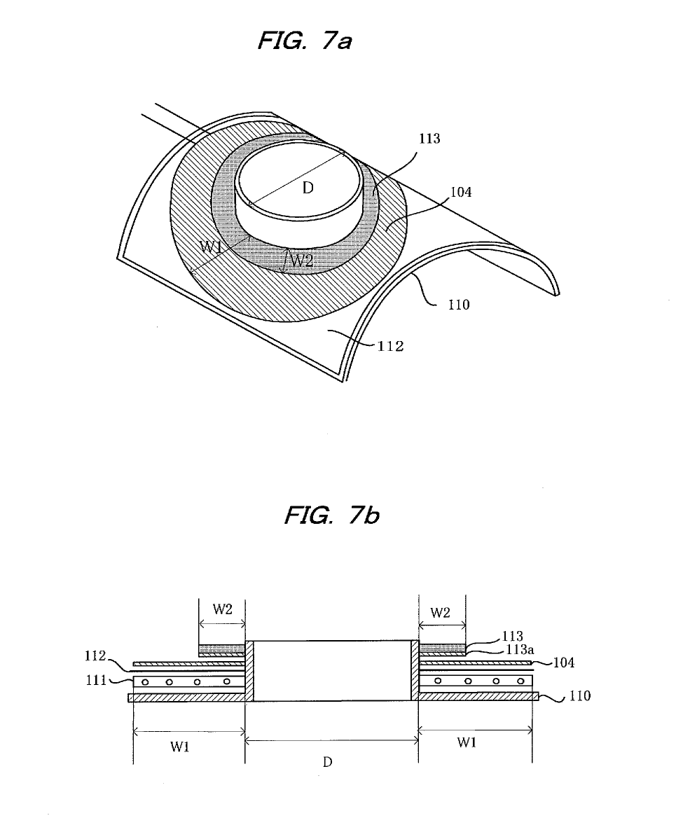

Next, as shown in FIGS. 7a and 7b, the annular lower resin sheet 104 of a thermoplastic resin and a sheet-shaped resin-absorbing material 113 are rested on the weld-preventing sheet 112. The resin-absorbing material 113 has a thermoplastic resin 113a thermally welded in an annular shape to the surface on the side opposite the flange (the lower surface in FIG. 7 (b)). The lower resin sheet 104 and the resin-absorbing material 113 with the thermoplastic resin 113a thereon constitutes a lower annular sheet member. The lower resin sheet 104 is annular of inside diameter equal to D and ring width equal to W1, and the resin-absorbing material 113 is an annular member of diameter equal to D and a ring width W2 smaller than W1. The resin of the thermoplastic resin 113a and of the lower resin sheet 104 is identical to the thermoplastic resin of the resin pipe 20a of the main pipe lining material, and the resin-absorbing material 113 is of the same material as the tubular resin-absorbing material 102.

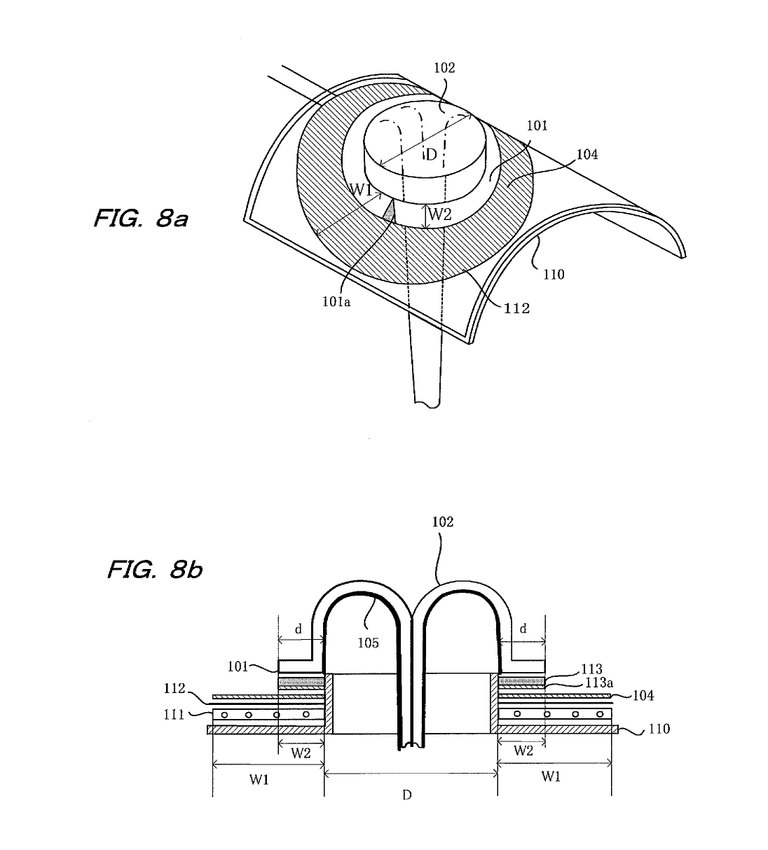

Next, as shown in FIGS. 8a and 8b, one end of the tubular resin-absorbing material 102 is everted, and this end (the portion of width d) is folded outwardly into a flange 101. The material 102 is arranged in the jig 110 in such a way that the flange 101 rides on the resin-absorbing material 113, while the other end of the tubular resin-absorbing material 102 passes down into the round tubular section of the jig 110. The setting of the flange 101 may be facilitated by forming a slit 101a at the end of the tubular resin-absorbing material 102 as shown in FIG. 8a. Preferably, the ring width W2 of the resin-absorbing material 113 is equal to the width d of the flange 101.

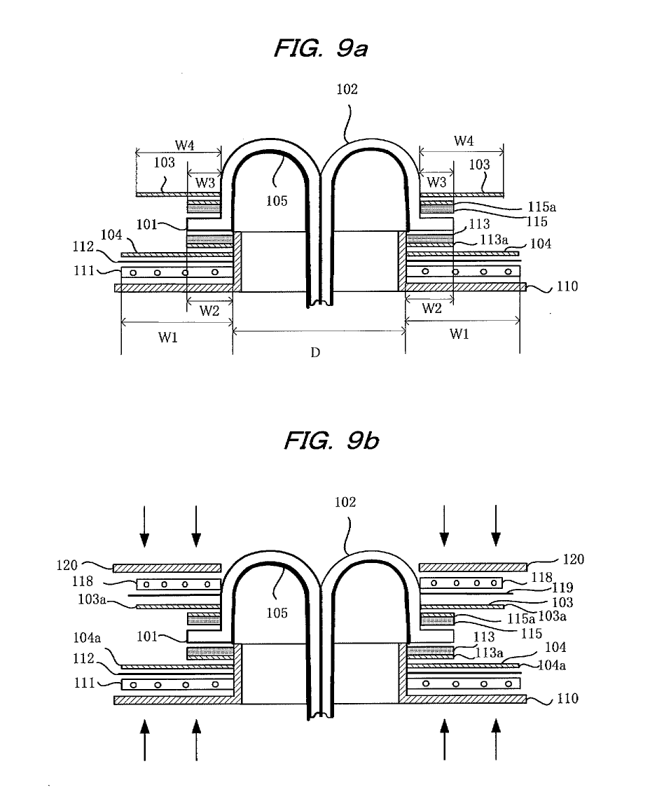

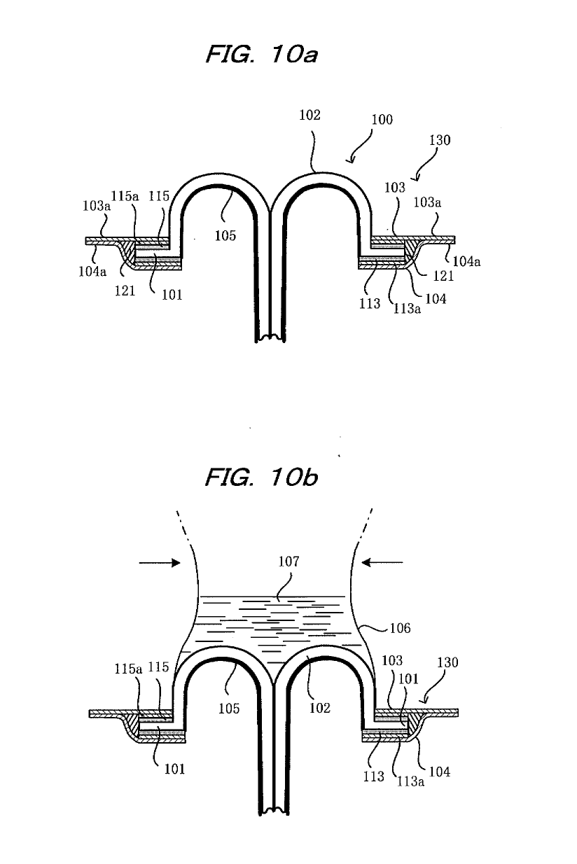

Thereafter, as shown in FIG. 9a, an annular resin-absorbing material 115 having a thermoplastic resin 115a thermally welded in an annular shape to the surface thereof on the side opposite the flange 101, together with the ring-shaped upper resin sheet 103 made of a thermoplastic resin, are stacked over the flange 101 with the upper resin sheet 103 on top. The resin-absorbing material 115 is of annular shape, with an inside diameter of substantially D and a ring width W3 smaller than W2 by the equivalent of the thickness of the tubular resin-absorbing material 102. The upper resin sheet 103 is annular in shape, with an inside diameter of substantially D and a ring width W4 smaller than W1. The thermoplastic resin 115a and the thermoplastic resin of the upper resin sheet 103 are both the same as the thermoplastic resin of the resin pipe 20a of the main pipe lining material, and the resin-absorbing material 115 is of the same material as the tubular resin-absorbing material 102.

Next, as shown in FIG. 9b, a heater 118 comparable to the heater 111 is laid over the upper resin sheet 103 via a weld-preventing sheet 119. The flange 101 and the resin-absorbing materials 113, 115 are respectively impregnated evenly, for example, with an unsaturated polyester resin, a vinyl ester resin, an epoxy resin, or other thermosetting resin, from the side using an injector.

Once impregnation with the thermosetting resin has been completed, a jig 120 curved in comparable fashion to the jig 110 is placed at the top, and the members are clamped between the jigs 120 and 110. The heaters 111, 118 are then supplied with electricity, and heat up to about 90° C. to 140° C. The thermosetting resins impregnated in the flange 101 and the resin-absorbing materials 113, 115 are cured and they are bonded together. Additionally, the upper resin sheet 103 and the thermoplastic resin 115a are thermally welded and bonded together, while the lower resin sheet 104 and the thermoplastic resin 113a are likewise thermally welded and bonded to one another. An outer edge 103a of the upper resin sheet 103 and an outer edge 104a of the lower resin sheet 104, which extend in a ring shape diametrically outward beyond the flange 101, are likewise thermally welded to bond the upper resin sheet 103 and the lower resin sheet 104 together (plastic welding).

Once bonding has been completed, the jigs 110, 120, the heaters 111, 118, and the weld-preventing sheets 112, 119 are removed, completing fabrication of the lateral pipe lining material 100 as shown in FIG. 10a.

When a thermosetting resin is impregnated in the resin-absorbing material of the flange 101 and is previously cured, the flange 101 remains firm (hard). Even if the flange is firm, the tubular resin-absorbing material 102 can be seated in the jig as shown in FIGS. 8a and 8b. In this case as well, the heaters 111, 118 are used to heat the thermosetting resins in the resin-absorbing materials 113, 115 for firmly bonding with the flange 101.

In FIG. 10a, reference numeral 121 shows a state in which the thermosetting resins in the flange 101 and the resin-absorbing materials 113, 115 have been squeezed out and cured under pressure by the jigs 110, 120. The resin sheets 103, 104, the resin-absorbing materials 113, 115, and the flange 101 are firmly bonded together by curing of the thermosetting resins, or through plastic welding of the thermoplastic resins, thus constituting a flange member 130 of the lateral pipe lining material.

The upper resin sheet 103 is the uppermost portion of the flange member, and must have close contact with the inside peripheral wall of the main pipe. The close contact cannot be provided reliably if the surface of the upper resin sheet 103 has asperities or unevenness. Consequently, the shapes of the jigs 110, 120 are determined in such a way that the curve of the upper resin sheet 103 will match the curve of the inside peripheral wall of the main pipe.

As shown in FIG. 10b, a resin impregnation tube 106 is attached to the tubular resin-absorbing material 102 to impregnate a thermosetting resin into the tubular resin-absorbing material 102. A thermosetting resin 107, for example, an unsaturated polyester resin, a vinyl ester resin, an epoxy resin, or the like is injected into the tube 106, which is then everted and inserted into the resin-absorbing material 102 for resin impregnation therein. In place of thermosetting resin, or in addition to thermosetting resin, a photocuring resin that cures when irradiated with ultraviolet may be impregnated. After the resin has been impregnated, the resin impregnation tube 106 is removed from the tubular resin-absorbing material 102.

The resin impregnation tube 106 may be attached to the tubular resin-absorbing material 102 just prior to the stage shown in FIG. 9a, that is, prior to disposition of the resin sheet 103, the resin-absorbing material 115 and the thermoplastic resin 115a on the flange 101.

The lining steps will be described in which the lateral pipe lining material 100 discussed above is employed for lining the lateral pipe 31 that branches from the main pipe 30 lined with the main pipe lining material 20 as shown in FIG. 3.

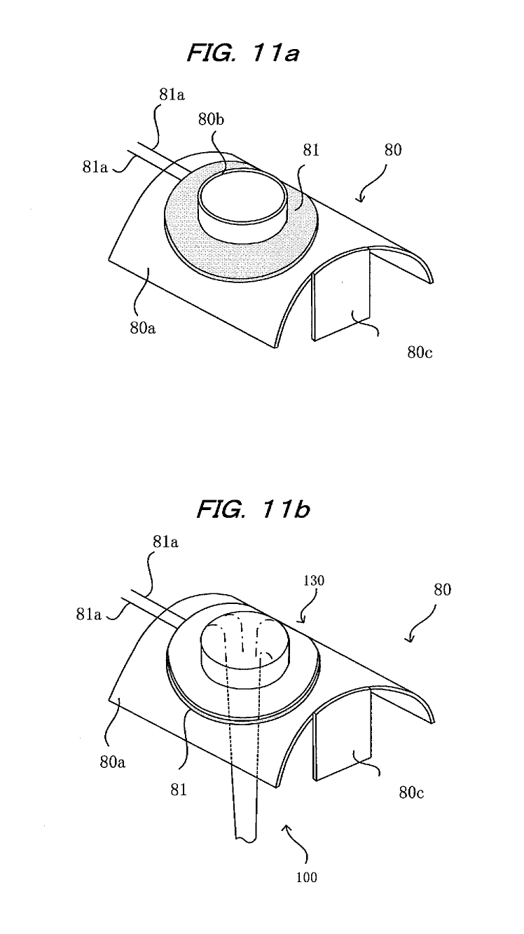

As shown in FIG. 11a, a head collar 80 made of metal is prepared that comprises a round tubular section 80b and a curved section 80a, like the jig 110, curving at substantially the same curvature as the inside peripheral surface of the main pipe 30 or as the flange of the lateral pipe lining material 100. An attachment plate 80c is secured to the curved section 80a of the head collar 80 to attach the head collar 80 to a work robot, discussed below. A heater 81 is attached to the head collar 80. The heater 81 includes a nichrome wire or the like to emit heat when supplied with electricity via a lead 81a, and is covered by a heat resistant, elastic material to impart elasticity thereto in the vertical direction in the drawing.

The lateral pipe lining material 100 is seated in the head collar 80 as shown in FIG. 11b.

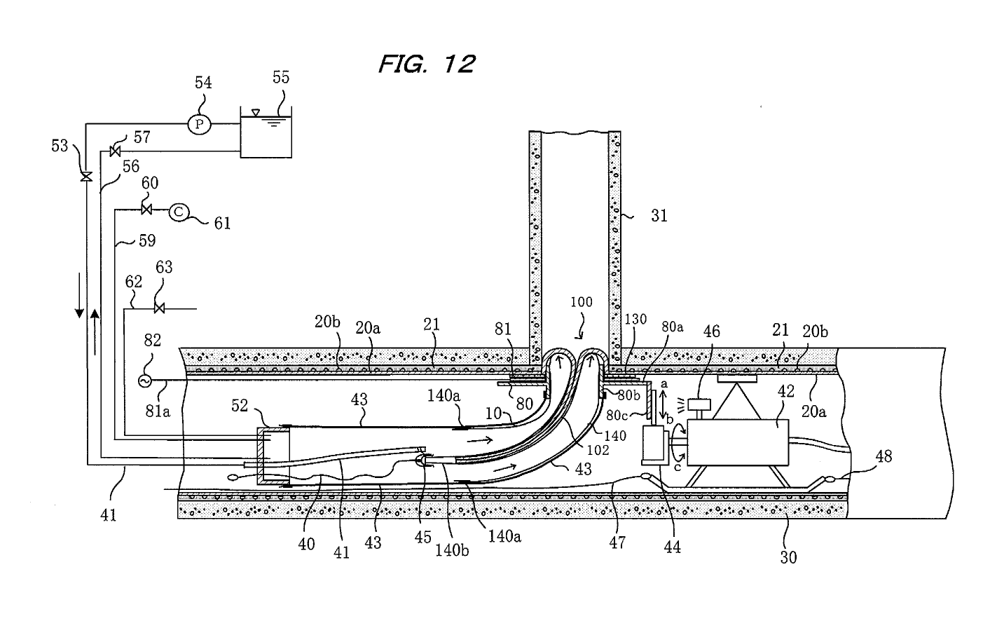

As shown in FIG. 12, a sealing tube 140 adapted to evert the lateral pipe lining material 100 is everted so as to encapsulate the non-everted portion of the lateral pipe lining material 100. The sealing tube 140 is airtightly secured at one end 140a to the inside surface of a pressure bag 43, and the other end 140b thereof is attached airtightly to a link fitting 45. As shown in FIG. 12, the non-everted portion of the lateral pipe lining material 100 seated in the head collar 80 is inserted into the interior of the sealing tube 140, and housed inside the pressure bag 43.

The round tubular section 80b of the head collar 80 is inserted into one end of the pressure bag 43 and attached airtightly thereto. On the other hand, an opening of the pressure bag 43 on the side opposite the head collar 80 is closed off airtightly by a cap 52.

A tow rope 40 and a hot water hose 41 attached airtightly to the cap 52 are linked to the link fitting 45 which closes off the other end 140b of the sealing tube 140. The hot water hose 41 passes through the cap 52 to the outside of the pressure bag 43, leading to a valve 53. The hot water hose 41 is supplied via a hot water pump 54 with hot water (heat medium) from a hot water tank 55 which is heated by a heat source (not shown). Hot water inside the pressure bag 43 is returned to the hot water tank 55 via a drain hose 56 and a valve 57.

Inside the pressure bag 43, there is formed a hermetic space which is closed off by the sealing tube 140. The hermetic space is connected to a compressor 61 installed above ground, via an air hose 59 and a valve 60. The hermetic space also communicates with the outside air via a vent hose 62 and a valve 63.

A work robot 42 is constituted such that a head 44 thereof extends and retracts in the vertical direction a, b in FIG. 12, while rotating (rolling) about a center on the pipe axis as shown by an arrow c. A TV camera 46 for monitoring purposes is installed on top of the work robot 42. The head collar 80 is attached to the distal end of the head 44 of the work robot 42 via the attachment plate 80c thereof. As the head 44 moves in the a, b, and c directions, the head collar 80 and the lateral pipe lining material 1 seated thereon likewise move in interlocking fashion therewith.

Tow ropes 47, 48 are attached to the front and back of the work robot 42 and pulled with a winch or the like to move the work robot 42 and the pressure bag 43 in the pipe lengthwise direction, in such a way that the center of the flange 3 of the lateral pipe lining material 100 aligns with the center of the opening 31a of the lateral pipe 31. In this state, the head 44 is, as shown in FIG. 12, moved in the vertical direction to bring the upper resin sheet 103 constituting the flange member 130 of the lateral pipe lining material 100 into close contact with the periphery of the lateral pipe opening of the main pipe 30 which is lined with the main pipe lining material 20.

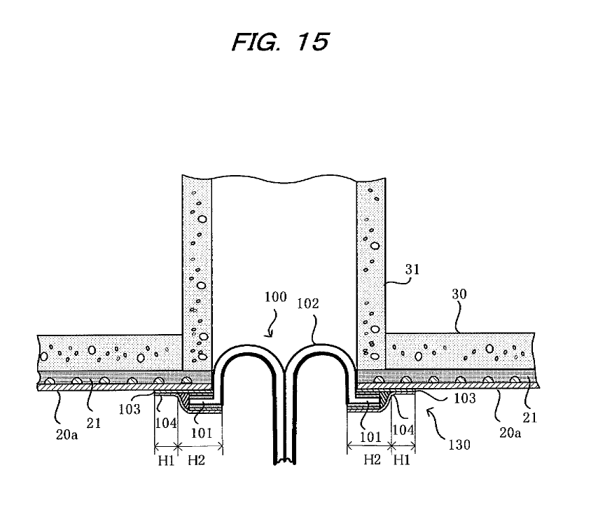

FIG. 15 shows in an enlarged cross section a state in which the upper resin sheet 103 is brought into close contact with the periphery of the lateral pipe opening of the main pipe 30. In FIGS. 12 to 14, the flange member 130 is shown in simplified form as a single member in order to avoid complexity in the drawings.

In this state, the compressor 61 is driven and compressed air (pressurized fluid) is supplied to the hermetic space inside the pressure bag 43 through the air hose 59. The sealing tube 140 is then everted while being expanded and inserted into the lateral pipe 31. The lateral pipe lining material 100 wrapped in the sealing tube 140 is also progressively inserted towards upward inside the lateral pipe 31 while undergoing eversion. At this time, the hot water hose 41 and the tow rope 40 which are linked to the sealing tube 140 via the link fitting 45 are also inserted into the lateral pipe 31.

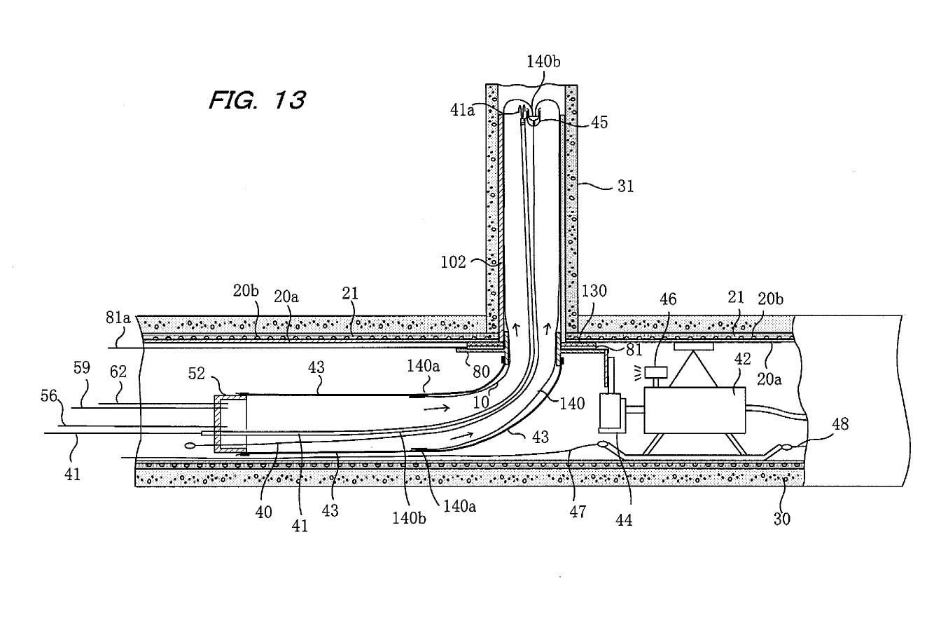

As shown in FIG. 13, after the tubular resin-absorbing material 102 has been everted and inserted into the lateral pipe 31, the tubular resin-absorbing material 102 is kept to be pressed against the inside peripheral surface of the lateral pipe 31, and hot water is supplied from a distal end 41a of the hot water hose 41 to fill the inside of the hermetic space therewith. The compressed air inside the hermetic space is released into the atmosphere through the vent hose 62, and the thermosetting resin impregnated into the tubular resin-absorbing material 102 is warmed and cured by the hot water supplied from the hot water tank 55.

When the lateral pipe lining material 100 is being everted and inserted into the lateral pipe 31, or the curing resin impregnated into the tubular resin-absorbing material is being cured after insertion or subsequent to insertion thereof, the heater 81 is powered by the power supply 82 via the lead 81a. The heater 81 heats the thermoplastic resin of the upper resin sheet 103 and the lower resin sheet 104 of the lateral pipe lining material 100 as well as the thermoplastic resin of the resin pipe 20a of the main pipe lining material 20 up to a temperature of approximately 105 to 150° C., for example. During this time, the resin sheets 103 and 104 are in a state of being pressed against the resin pipe 20a, assuring a reliable plastic welding of the respective thermoplastic resins. The heating temperature is set to an appropriate temperature within a range of approximately 105 to 150° C., depending on the material of the thermoplastic resins. The thermoplastic resin of the upper resin sheet 103 and the lower resin sheet 104 and the thermoplastic resin of the resin pipe 20a are the same resin, for example, polyethylene or polypropylene resin, and are therefore easily and reliably welded. This allows the flange member 130 of the lateral pipe lining material 100 and the resin pipe 20a of the main pipe lining material 20 to be integrally bonded, preventing inflow of underground water together with sediment into the main pipe from the joined section of the main pipe and the lateral pipe.

In the present embodiment, an area, denoted as H1 in FIG. 15, that lies at the outside edges in the radial direction of the upper resin sheet 103 and the lower resin sheet 104 is made of soft thermoplastic resin. On the other hand, the remaining interior area, denoted as H2, has been hardened through curing of the thermosetting resin. Consequently, even if asperities or unevenness is present in the hardened area H2, the outside peripheral area H1 of the flange member 130 will reliably undergo plastic welding with the lining material of the main pipe 30 for integral bonding therewith. This advantageously improves the effect of preventing inflow of underground water together with sediment into the main pipe from the joined section of the main pipe and the lateral pipe.

The thermoplastic resin of the flange member of the lateral pipe lining material and of the main pipe lining material may be heated before the flange member 130 of the lateral pipe lining material 100 comes into close contact with the periphery of the lateral pipe opening of the main pipe and before the tubular resin-absorbing material 102 is everted and inserted into the lateral pipe 31, as shown in FIG. 12, that is, before the compressor 61 is driven to supply compressed air to inside the pressure bag.

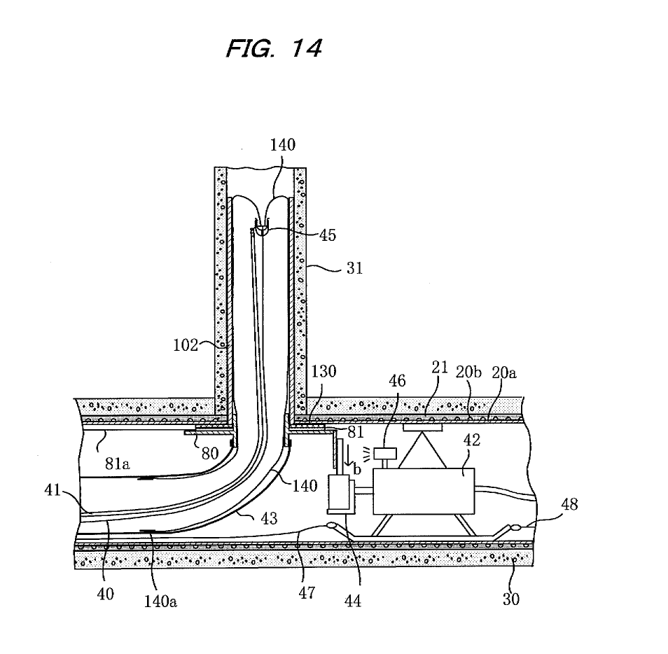

After the resin impregnated into the tubular resin-absorbing material 102 has cured, the hot water is drained from the hermetic space via the drain hose 56, and returned to the hot water tank 55. After the hot water is returned to the hot water tank 55, while applying a certain extent of pressure to the hermetic space, the tow rope 40 and the hot water hose 41 are pulled in the leftward direction in FIG. 14 to evert the sealing tube 140 for removal from the lateral pipe lining material 100.

Next, the head 44 of the work robot 42 is moved downward in the direction of arrow b, the head collar 80 and the heater 81 are separated from the flange member 130 of the lateral pipe lining material 100, and thereafter the work robot 42, the pressure bag 43, etc., are extracted from inside the main pipe 30. In this way, the lateral pipe 31 is lined on the inside peripheral surface thereof by the tubular resin-absorbing material 102.

The hot water hose 41 may be provided with a plurality of spray holes, and the resin impregnated into the tubular resin-absorbing material 102 may be cured by spraying hot water or water vapor from these spray holes onto the tubular resin-absorbing material 102 in a shower pattern or mist pattern.

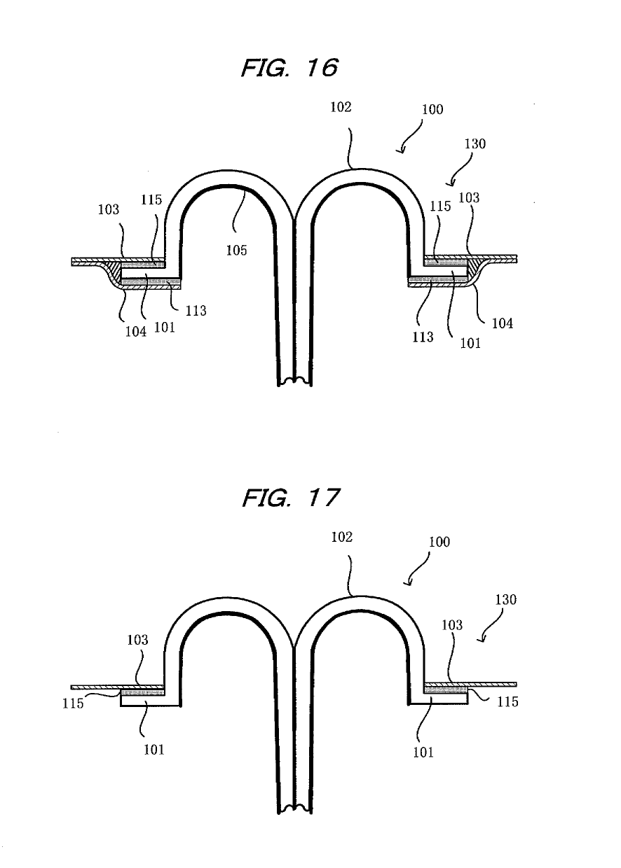

In the embodiment discussed above, the thermoplastic resin of the upper resin sheet 103 is thermally welded to the thermoplastic resin 115a which was previously thermally welded to the resin-absorbing material 115, and likewise, the thermoplastic resin of the lower resin sheet 104 is thermally welded to the thermoplastic resin 113a which was previously thermally welded to the resin-absorbing material 113. However, as shown in FIG. 16, the thermoplastic resins 115a, 113a are optionally omitted, instead the upper resin sheet 103 can be thermally welded directly to the resin-absorbing material 115, and the lower resin sheet 104 directly to the resin-absorbing material 113. In this case, the upper resin sheet 103 is thermally welded to the resin-absorbing material 115, and the lower resin sheet 104 is thermally welded to the resin-absorbing material 113, and thereafter the resin-absorbing materials 115, 113 are impregnated with thermosetting resin.

In the flange member of the embodiment discussed above, the resin sheet and the resin-absorbing material are provided also below the flange 101. However, as shown in FIG. 17, the resin-absorbing material 115 and the resin sheet 103 may be provided only to the lateral pipe side (top) of the flange 101. In this case, the resin sheet 103 and the resin-absorbing material 115 would be thermally welded, and the flange 101 and the resin-absorbing material 115 would be impregnated with a thermosetting resin and cured and bonded together, thereby obtaining the integrated flange member 130.

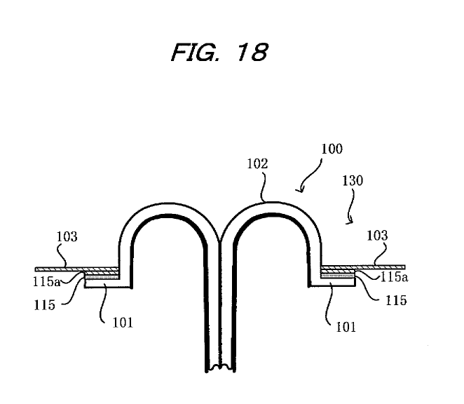

Likewise, as shown in FIG. 18, an embodiment would be conceivable in which the resin sheet 103 and the resin-absorbing material 115 with the thermoplastic resin 115a thermally welded thereon are provided only to the top of the flange 101. In this case, the thermoplastic resin of the resin sheet 103 and the thermoplastic resin 115a are thermally welded, and the flange 101 and the resin-absorbing material 115 are impregnated with a thermosetting resin and cured. Thus, the flange 101 and the resin-absorbing material 115 can be bonded to obtain the integrated flange member 130.

In the embodiments discussed above, the resin sheet 103, the resin-absorbing material 115, and the thermoplastic resin 115a which are disposed above the flange 101, as well as the resin sheet 104, the resin-absorbing material 113, and the thermoplastic resin 113a which are disposed below the flange 101, are all of annular shape, and the resin-absorbing materials 115 and 113 as well as the thermoplastic resins 115a and 113a have a ring width substantially equal to the width of the flange 101. Therefore, the outer edges of the resin-absorbing materials 115, 113 and of the thermoplastic resins 115a, 113a are at the same position as the outer edge of the flange 101 as viewed in the radial direction, as shown in FIG. 9. On the other hand, the ring width of the resin sheets 103, 104 is greater than that of the flange, and the outer edges thereof extend outwardly beyond the flange, making them longer than the width of the flange. However, depending on the bond strength of the members, the respective ring width of the resin sheets 103, 104, of the resin-absorbing materials 115 and 113, and of the thermoplastic resins 115a and 113a can be varied. For example, the ring width of the resin sheets 103, 104 can be made smaller, so as to be substantially equal to or smaller than the width of the flange 101. Additionally, the ring width of the resin-absorbing materials 115 and 113, and of the thermoplastic resins 115a, 113a, can be made longer or shorter than the width of the flange 101. Furthermore, each of the members 103, 115, 115a, 104, 113, 113a, etc. in the embodiments is circular in shape at the outer edge. However, there is no limitation to a circular shape, and an ellipsoidal shape, a rectangular shape, or a shape having corners in a portion thereof is also acceptable.

In the embodiments discussed above, the thermoplastic resin of the main pipe lining material, and the thermoplastic resin of the resin sheet disposed to the top (lateral pipe) side of the flange may respectively be made from polyvinyl chloride (PVC).

What is claimed is:

1. A lateral pipe lining material comprising a flexible tubular resin-absorbing material that is folded back at one end to form a flange and is inserted into a lateral pipe that intersects with a main pipe lined with a lining material of a thermoplastic resin, comprising:
an annular resin sheet disposed at a side of the flange facing towards the lateral pipe and comprised of a thermoplastic resin capable of being thermally welded to the lining material of the main pipe; and
an annular resin-absorbing material disposed between the resin sheet and the flange;
wherein the resin sheet and the annular resin-absorbing material are thermally welded, and each of the flange and the annular resin-absorbing material is impregnated with a thermosetting resin, which is cured to join the flange and the annular resin-absorbing material.

2. The lateral pipe lining material according to claim 1, wherein a thermoplastic resin is thermally welded to the annular resin-absorbing material in an annular shape, and the resin sheet is thermally welded to the annular resin-absorbing material via the thermoplastic resin.

3. The lateral pipe lining material according to claim 1, wherein an annular resin-absorbing material and an annular resin sheet made of a thermoplastic resin are disposed to the side of the flange opposite the lateral pipe, and the thermoplastic resin of the resin sheet is thermally welded to the annular resin-absorbing material, the annular resin-absorbing material being impregnated with a thermosetting resin, which is cured to bond the flange and the resin-absorbing material together.

4. The lateral pipe lining material according to claim 3, wherein a thermoplastic resin is thermally welded in an annular shape to the annular resin-absorbing material disposed to the side of the flange opposite the lateral pipe, and the resin sheet disposed to the side opposite the lateral pipe is thermally welded to the annular resin-absorbing material via the thermoplastic resin.

5. The lateral pipe lining material according to claim 4, wherein the resin sheets disposed to the lateral pipe side of the flange and to the opposite side thereof respectively extend in an annular shape outwardly in the radial direction beyond the flange and are thermally welded at the outer edges.

6. The lateral pipe lining material according to claim 1, wherein the thermoplastic resin of the resin sheet disposed to the lateral pipe side of the flange is a resin identical to the thermoplastic resin of the lining material of the main pipe, and is polyethylene, polypropylene, or polyvinyl chloride.

7. A method for producing a lateral pipe lining material comprising a flexible tubular resin-absorbing material that is folded back at one end to form a flange and is inserted into a lateral pipe that intersects with a main pipe lined with a lining material of a thermoplastic resin, comprising:
disposing at a side of the flange facing towards the lateral pipe an annular resin sheet comprising a thermoplastic resin capable of being thermally welded to the lining material of the main pipe;
disposing an annular resin-absorbing material between the resin sheet and the flange;
impregnating each of the flange and the annular resin-absorbing material with a thermosetting resin; and
heating the flange, the annular resin-absorbing material and the resin sheet to weld the resin sheet and the annular resin-absorbing material and to cure the thermosetting resin in the flange and the annular resin-absorbing material, thereby joining the flange and the annular resin-absorbing material.

8. The method for producing a lateral pipe lining material according to claim 7, wherein a thermoplastic resin is thermally welded in an annular shape to the annular resin-absorbing material, and the resin sheet is thermally welded to the annular resin-absorbing material via the thermoplastic resin.

9. The method for producing a lateral pipe lining material according to claim 7, wherein an annular resin-absorbing material and an annular resin sheet comprising a thermoplastic material are disposed to the side of the flange opposite the lateral pipe, and when the flange, the annular resin-absorbing material and the resin sheet on the lateral pipe side thereof are heated, the resin sheet and the annular resin-absorbing material on the side opposite the lateral pipe are also heated for plastic welding, and the flange and the annular resin-absorbing material on the side opposite the lateral pipe are heated to cure the respective thermoplastic resins impregnated therein.

10. The method for producing a lateral pipe lining material according to claim 9, wherein a thermoplastic resin is thermally welded in an annular shape to the annular resin-absorbing material disposed to the side of the flange opposite the lateral pipe, and the resin sheet disposed to the side opposite the lateral pipe is thermally welded to the annular resin-absorbing material via the thermoplastic resin.

11. The method for producing a lateral pipe lining material according to claim 10, wherein the resin sheets disposed to the lateral pipe side of the flange and to the opposite side thereof extend in an annular shape outwardly in the radial direction beyond the flange and are thermally welded at the outer edges.

12. The method for producing a lateral pipe lining material according to claim 7, wherein the thermoplastic resin of the resin sheet disposed to the lateral pipe side of the flange is a resin identical to the thermoplastic resin of the lining material of the main pipe, and is polyethylene, polypropylene, or polyvinyl chloride.

13. A lateral pipe lining process for lining a lateral pipe, employing the lateral pipe lining material according to claim 1, comprising:
impregnating the tubular resin-absorbing material of the lateral pipe lining material with a curing resin;
disposing the lateral pipe lining material impregnated with the curing resin such that a flange thereof is pressed against the main pipe in the vicinity of an opening of the lateral pipe;
applying pressure to the lateral pipe lining material for eversion and insertion into the lateral pipe;
curing, after eversion and insertion, the resin impregnated into the lateral pipe lining material in a state in which the lateral pipe lining material is pressed against the lateral pipe inside peripheral wall, thereby lining the lateral pipe; and
heating the resin sheet on the lateral pipe side while being pressed against the lining material of the main pipe at the beginning of insertion of the lateral pipe lining material, or during insertion, or after insertion thereof for welding to the lining material of the main pipe.
